(19) United States
(12) Patent Application Publication
(10) Pub. No.: US 2011/0185908 A1
(43) Pub. Date: Aug. 4, 2011

(54) DEVICE FOR SEPARATING DIFFERENT ENCLOSED SPACES AND FOR DOSING A FOOD PRODUCT AND MACHINE INCORPORATING SAID DEVICE

(75) Inventor: Giovanni Berto, Olmi Di San Biagio Di Callalta (IT)

(73) Assignee: KONINKLIJKE PHILIPS ELECTRONICS N.V., EINDHOVEN (NL)

(21) Appl. No.: 12/997,886

(22) PCT Filed: Jun. 26, 2009
(86) PCT No.: PCT/IT09/00281

§ 371 Date: Mar. 3, 2011

(30) Foreign Application Priority Data
Jun. 30, 2008 (IT) FI2008A000121

(51) Int. Cl. A47J 31/42; B67D 7/16

(52) U.S. Cl. 99/286; 222/71

(57) ABSTRACT

The device (9) comprises a dosing element (23) housed in a housing seat (21) equipped with an inlet (21A) for feed of the food product and with an outlet (21B) for dispensing the food product. The dosing element rotates in the housing seat and has a hollow body with an opening (23B) for feed and delivery of the food product. With rotation of the dosing element the hollow body can be taken into alignment alternatively with the inlet or with the outlet of the housing seat (21).

### TECHNICAL FIELD

The present invention relates to the field of machines for preparing beverages, in particular machines able to prepare coffee based beverages, such as, but not only, espresso coffee machines for domestic or professional use, automatic dispensers and the like.

More in particular, the present invention relates to improvements to coffee machines of the type using beans, i.e. incorporating a coffee grinder which produces ground coffee from beans coming from a container, but can also be applied to machines which use previously ground coffee.

### STATE OF THE ART

In the domestic field, but also in the professional field and in automatic dispensing machines, there are frequently used manual, semi-automatic or automatic machines, including a coffee bean container from which, when dispensing of a coffee-based beverage is requested, a predetermined quantity of beans is dosed and subsequently ground in a coffee grinder. The ground coffee obtained is compacted in a brewing unit in which, by means of passage of hot water, the aromas are extracted from the ground coffee to produce the beverage.

According to the size of the bean container and to the frequency with which the machine is used, the raw material, i.e. the coffee beans with which the beverage is prepared, can undergo deterioration due to progressive oxidation of the roasted beans in contact with the air. This oxidation has a negative influence on the organoleptic properties of the beverage obtained. Similar problems are encountered when the machine is equipped with a container for ground coffee instead of coffee beans. In this case, the problems of oxidation can be even greater, due to the larger contact surface with the ambient air of ground coffee with respect to coffee beans.

Similar problems can occur in the dosing of other food products, also in the same type of machines mentioned above. In fact, these machines can be equipped with circuits to dispense milk to prepare cappuccino, hot milk, milk coffee or the like. Also in this case, contact of the food with the air can cause deterioration of the product.

### SUMMARY OF THE INVENTION

According to one aspect the invention aims at solving the aforesaid problems entirely or in part.

In substance, according to one embodiment, the invention provides for a space separation and dosing device for a food product, for example and in particular coffee, interfaceable with a container for the food product equipped with a passage of the food product towards an inlet of a housing seat of a rotating dosing element. The seat also has an outlet for dispensing the food product, and the dosing element has a hollow body with an opening for feed and delivery of the food product in the inner cavity of the rotating dosing element, so that by rotating said dosing element the opening of the hollow body can be put alternatively into alignment with the inlet or with the outlet of the seat in which the dosing element is housed. The food product enters the hollow volume of the dosing element, for example, by simply falling and, after a rotation of approximately 180°, is discharged into a hopper or other member below to be conveyed towards the component of the machine downstream.

In this manner the dual function is obtained of dispensing predetermined doses of food product while preventing or in any case reducing the connection between the space (container) in which the food product is located and the external or other space in which the food product is dispensed. This effectively reduces, for example, contact between atmospheric oxygen and the food product stored in the container.

In some embodiments, the food product contained in the container is coffee beans, and the dosing device dispenses the coffee beans in a dosed manner to a coffee grinder associated therewith, which performs grinding and feeds the ground coffee to a brewing unit. According to other embodiments, the container can contain previously ground coffee and therefore the dosing device is used to dispense the ground coffee directly to a brewing unit below. In other embodiments it would be possible for the container to enclose therein not only the coffee, but also the coffee grinder. In this case the coffee is again in beans, but the space separation and dosing device is used to dispense previously ground coffee, for example by discharging it directly towards the brewing unit.

In other embodiments, the space separation and dosing device can be applied to a container for milk or another food product contained in the beverage dispensing machine.

With this type of arrangement, a controlled atmosphere can be maintained in the container, for example with a high nitrogen content or another inert gas, to prevent or in any case limit oxidation of the food product. The degree of humidity or other characteristics of the storage atmosphere of the food product, for example coffee, either in beans or ground, can also be advantageously controlled.

Further advantageous features and embodiments of the device according to the invention are indicated in the appended claims and will be described in greater detail below with reference to an example of application.

According to a further aspect, the invention also relates to a machine for preparing beverages, in particular coffee, preferably but not necessarily an automatic espresso coffee machine, which comprises a dosing device of the type specified above.

### BRIEF DESCRIPTION OF THE DRAWINGS

The invention will be better understood by following the description and accompanying drawing, which shows a non-limiting embodiment of the invention. More in particular:

FIG. 1 shows a diagram of the main components of a coffee machine incorporating the device according to the invention;

FIG. 2 shows an enlarged view of a dosing device according to the invention;

FIG. 3 shows a view according to III-III of FIG. 2;

FIG. 4 shows a cross-sectional view according to IV-IV of FIG. 2; and

FIG. 5 shows a cross-sectional view according to V-V of FIG. 3.

### DETAILED DESCRIPTION OF AN EMBODIMENT OF THE INVENTION

Application of the invention for dosing coffee beans and for space separation between the coffee container and the external space is described hereunder. However, as mentioned in the introduction of the present description, the invention can also be applied in other circumstances, where it is necessary to separate a space containing a food product from an external space or in any case from another space differing from that in which the food product is stored.

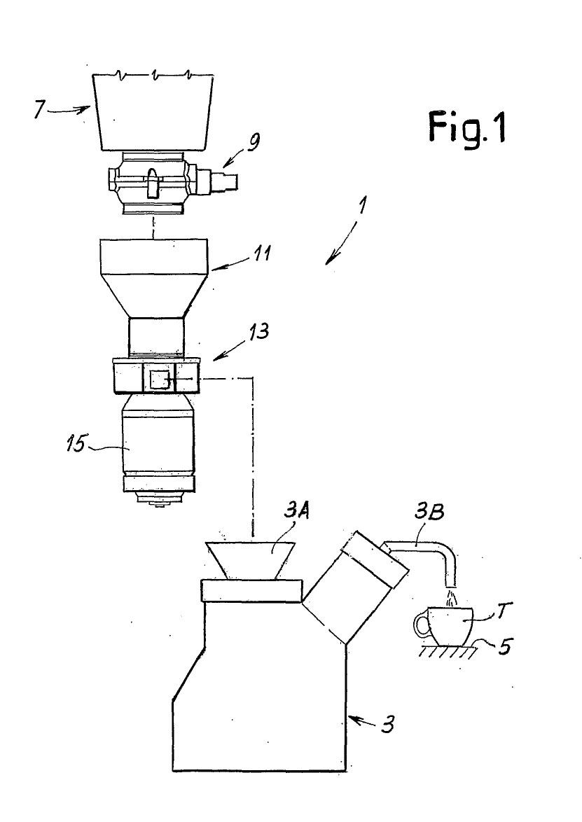

In FIG. 1, the assembly of the main elements of the coffee machine, limited to those parts necessary in order to understand the present invention, is indicated as a whole with 1. The reference 3 indicates a brewing unit, known per se, with a feed hopper 3A into which the ground coffee for preparation of the beverage is fed. The reference 3B indicates a beverage dispensing nozzle which is in alignment with a surface 5 on which a beaker or cup T into which the beverage is dispensed can be positioned. The ground coffee which feeds the brewing unit 3 is produced from coffee beans contained in a container 7 advantageously equipped with sealed closing means and/or associated with a system for producing and maintaining a controlled atmosphere inside the container 7.

Positioned under the container 7 is a space separation and dosing device 9, i.e. a device for dosing a predetermined quantity of coffee beans towards the mouth 11 of a coffee grinder 13, the drive motor of which is indicated with 15. The reference 9X indicates a generic interface, i.e. a mutual connection between the container 7 and the device 9. It must be understood that this interface can take any suitable form, for example it can be formed by a duct even of considerable length.

As will be apparent from the description below, this device 9 is called space separation as it allows a certain degree of separation to be obtained between the inner volume of the container 7 (or other space with which the device 9 is interfaced) and the external space.

The various members and actuators associated with the components described above are controlled appropriately by a control unit, with which the coffee machine 1 is equipped (not shown). The control unit controls the space separation and dosing device 9 in the manner described below, as well as the motor 15 of the coffee grinder 13 and the brewing unit 3, these latter in a manner known per se and not described in detail herein.

The space separation and dosing device 9 has the function of dispensing quantities of coffee, preset or settable by the user, to the coffee grinder 13, collecting said coffee beans from the container 7 preventing atmospheric oxygen, which can cause oxidative damage to the coffee stored in the container 7, from entering the container or in any case limiting the entry of oxygen therein.

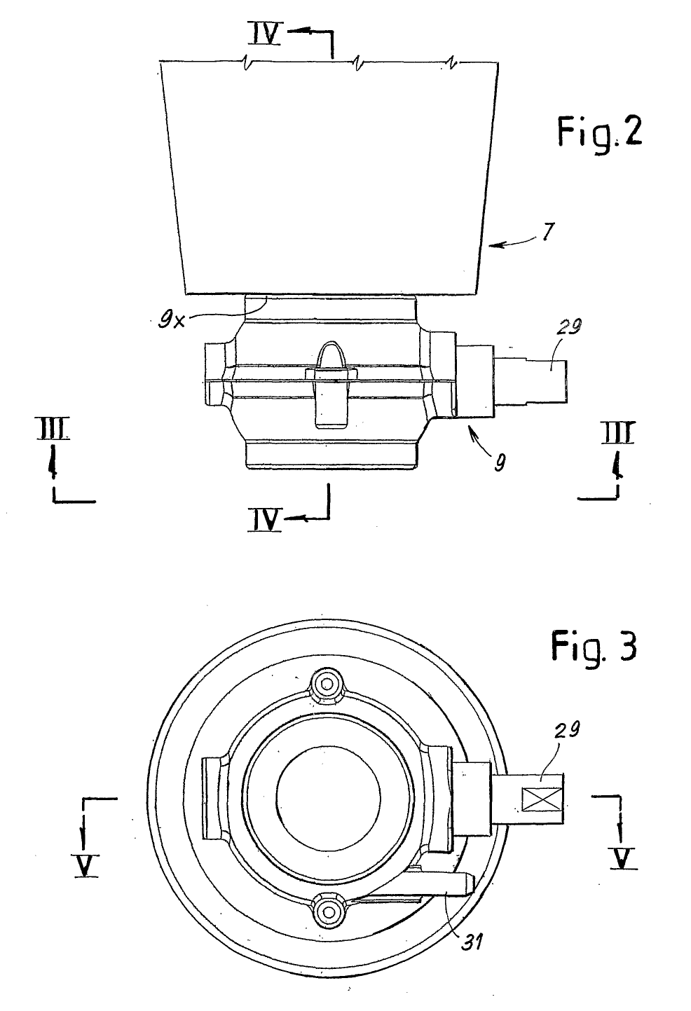

For this purpose, the space separation and dosing device 9 substantially has the structure shown in greater detail in Figures. 2 to 5. The space separation and dosing device 9 comprises a seat 21 with an inlet 21A for feeding coffee beans coming from the container 7 towards the inside of the housing seat 21. Said seat also has an outlet 21B for the coffee beans. Housed inside the housing seat 21 is a dosing element 23 rotating about an axis A-A in the manner described below. The dosing element 23 comprises a hollow body, with an inner volume 23A and an opening 23B for feed and delivery of the coffee beans. The dosing element 23 can rotate in the housing 21 due to its body of revolution shape about the axis A-A. The shape of the dosing element can be substantially cylindrical, or preferably substantially spherical, although other shapes are possible providing they are suitable to cooperate with seals 25, 27 arranged around the inlet 21A and the outlet 21B of the housing 21.

As shown in particular in FIG. 5, in the embodiment shown the dosing element 23 is coupled with a drive shaft 29 which can in turn be connected to an actuator, such as an electric motor or a lever, a handwheel or another manually operated member, with which rotation of the dosing element about the axis A-A is obtained for the purposes described below.

According to some embodiments, the inner volume of the housing seat 21 in which the dosing element 23 rotates can be in connection with a suction duct 31, in turn connected to a vacuum line with a suction fan. According to other embodiments, the inner volume of the housing seat 21 can be in connection with an inert gas feed line, for example nitrogen. The duct 31 flows in 31A (FIG. 5) into the volume of the housing seat 21 in which the dosing element 23 is disposed in a rotating manner.

Operation of the space separation and dosing device 9 described above is as follows. As mentioned previously, the container 7 is preferably an airtight container and/or associated with systems which maintain a controlled atmosphere therein, for example prevalently composed of nitrogen or another inert gas. This has the purpose of storing the coffee beans in optimal condition inside the container.

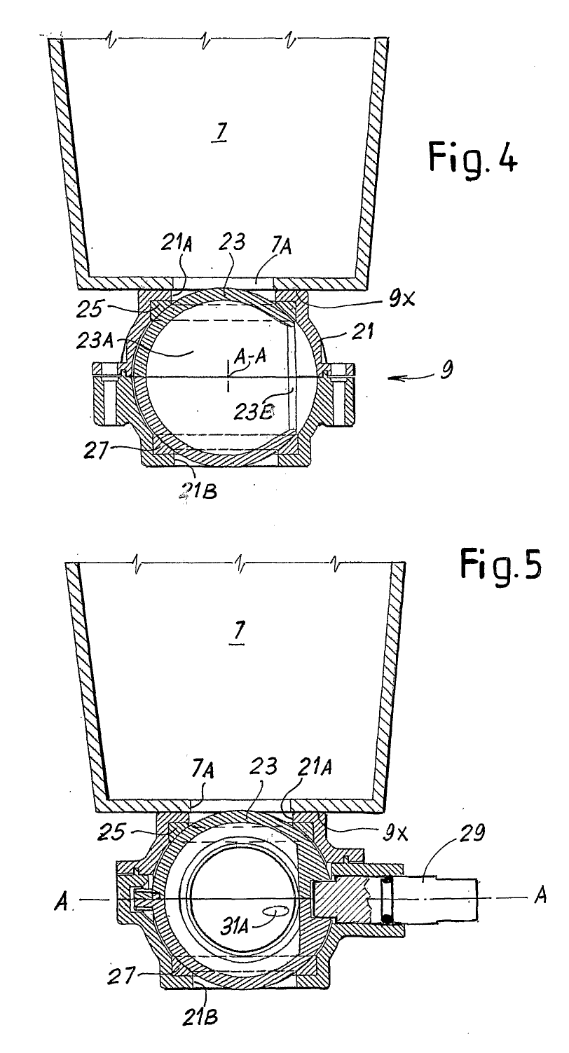

When the container 7 does not require to dispense coffee, the space separation and dosing device 9 can take the position of FIG. 4, so that the passage 7A which places the container 7 in connection with the opening 21A and with the seat 21 is isolated with respect to the outlet 21 B of the seat 21 by the dosing element 23 which acts as shutter. The seal is guaranteed by the sealing rings 25 and 27 which surround the inlet 21A and the outlet 21B of the housing seat 21. An inert gas, such as nitrogen or another suitable gas, can be present inside the volume of the seat 21 to create a controlled atmosphere, or a certain degree of vacuum can be produced due to suction through the duct 31.

When the user requests dispensing of one or more cups of coffee, the dosing element 32 is made to rotate so that its opening 23B is initially taken into alignment with the inlet 21A and the passage 7A. In this manner the inner volume of the hollow body defined by the dosing element 23 is filled with beans simply falling from the container 7. Subsequent rotation of 180° of the dosing element 23 about the axis A-A takes the opening 23B into alignment with the outlet 21B of the seat 21, so that the beans collected inside the hollow volume 23A of the dosing element 23 fall by gravity into the hopper 11 of the coffee grinder 13. According to the size of the hollow volume 23A of the dosing element 23 and/or to the predetermined quantity of coffee beans requested to be dispensed and/or to the number of cups of coffee requested, the brewing cycle can require the dosing element 23 to rotate more than once, for example two or three times, until reaching the quantity of coffee beans requested in the hopper 11 of the coffee grinder 13. Rotation can be a rotation of 360° or an oscillating rotation of 180°, i.e. the dosing element can rotate in a continuous or alternating manner. Due to the sealing rings 25, 27 which conform to the shape of the housing seat 21 and of the dosing element 23, this dispensing cycle with single or multiple rotation minimizes entry of air into the container 7, which therefore remains in optimal conditions with regard to the composition of the controlled atmosphere therein. The storage conditions of the coffee inside the container 7 are thus substantially improved with respect to conventional containers which are completely immersed in the atmosphere.

The use of a suction duct 31, or of a duct 31 which feeds inert gas into the housing seat 21 and therefore into the hollow volume 23A of the dosing element 23, can further improve the storage conditions of the coffee inside the container 7. In fact, in this case the air which penetrates the hollow compartment 23A of the dosing element 23, when this latter rotates downwards to turn the opening 23B towards the outlet 21B, is sucked out or expelled and replaced with inert gas when, after the coffee has been discharged through the outlet 21B, the dosing element 23 rotates again to the intermediate position of FIG. 4 (or to a position rotated by 180° with respect thereto) before moving to the subsequent loading position, in which the opening 23B of the dosing element 23 is once again aligned with the inlet 21A and with the passage 7A and therefore in connection with the container 7.

Ultimately, the space separation and dosing device 9 substantially improves the storage conditions of the coffee in the container 7 even for long periods, preventing or in any case appreciably limiting oxidation thereof. It can also be useful for correct dosing of the quantity of coffee requested for each single dispensing cycle.

As mentioned previously, in other embodiments the coffee grinder 13, which in the example shown is positioned downstream of the space separation and dosing device, could be housed inside the container 7, which in this case will have adequate dimensions. It is therefore possible to prevent or in any case limit oxidation of the ground coffee which remains in the coffee grinder.

It is understood that the drawing shows just one example, provided merely as a practical demonstration of the invention, which can vary in its forms and arrangements, without however departing from the scope of the concept underlying the invention. Any reference numbers in the appended claims are provided to facilitate reading of the claims with reference to the description and to the drawing, and do not limit the scope of protection represented by the claims.

1. A space separation and dosing device of a food product which can be associated with a container for the food product, said device comprising a dosing element housed in a housing seat equipped with an inlet for feed of the food product and with an outlet for dispensing the food product, wherein said dosing element rotates in said seat and has a hollow body with an opening for feed and delivery of the food product, rotation of said dosing element taking the opening of the hollow body alternatively into alignment with the inlet or with the outlet of said seat.

2. A device according to claim 1, comprising sealing members between said seat and said rotating dosing element to separate the inlet and the outlet of said seat.

3. A device according to claim 2, wherein said sealing members comprise a first gasket surrounding the inlet and a second gasket surrounding the outlet of said seat, the rotating dosing element having an outer surface in contact with said gasket and sliding thereon when said dosing element rotates in said seat.

4. A device according to claim 1, wherein said rotating dosing element has the shape of a solid of rotation and preferably a substantially hollow spherical shape.

5. A device according to claim 1, wherein said seat has a connection to a control line of the atmosphere in said seat.

6. A device according to claim 5, wherein said line is a suction line.

7. A device according to claim 5, wherein said line is an inert gas feed line.

8. A device according to claim 1, associated with a vacuum or controlled atmosphere system.

9. A machine for preparing a beverage comprising at least one container for a food product and a space separation and dosing device according to claim 1.

10. A machine according to claim 9, to prepare coffee.

11. A machine according to claim 10, comprising a coffee grinding unit which receives coffee beans from said dosing device and feeds ground coffee obtained by grinding said coffee beans to the brewing unit.
